(19) United States
(12) Patent Application Publication
(10) Pub. No.: US 2018/0121972 A1
(43) Pub. Date: May 3, 2018

(54) DIRECT PAYMENT SYSTEM FOR WEB CONSUMERS

(71) Applicant: INTERNATIONAL BUSINESS MACHINES CORPORATION, ARMONK, NY (US)

(72) Inventors: Carmine M. DiMascio, West Roxbury, MA (US); Benjamin L. Johnson, Baltimore, MD (US); Ashok Kumar, North Chelmsford, MA (US); Timothy P. Winkler, Clinton, MA (US)

(21) Appl. No.: 15/341,437

(22) Filed: Nov. 2, 2016

(51) Int. Cl. G06Q 30/04; G06Q 20/10; G06Q 20/22

(52) U.S. Cl. CPC G06Q 30/04; G06Q 20/22; G06Q 20/102

(57) ABSTRACT

A method for distributing a plurality of funds to a plurality of content creators is provided. The method may include registering a content creator using a plurality of content creator identifying information when a user visits a content creator webpage. The method may also include receiving a plurality of user interaction data when the user visits the content creator webpage of a registered content creator. The method may further include generating an invoice based on the received plurality of user interaction data. The method may also include disbursing at least one payment to the registered content creator based on the generated invoice.

### BACKGROUND

The present invention relates, generally, to the field of computing, and more particularly to payment systems.

A payment system is a system used to process transactions, usually monetary transactions, between entities. Typically, a payment system operates as a network that creates a monetary exchange between individual accounts, such as bank accounts, to allow for the transfer of money. Payment systems may be physical or, with the rise of computing, electronic. Payment systems may include debit cards, credit cards, electronic fund transfers, direct credits, direct debits, internet banking, and e-commerce payment systems.

### SUMMARY

According to one embodiment, a method for distributing a plurality of funds to a plurality of content creators is provided. The method may include registering a content creator using a plurality of content creator identifying information when a user visits a content creator webpage. The method may also include receiving a plurality of user interaction data when the user visits the content creator webpage of a registered content creator. The method may further include generating an invoice based on the received plurality of user interaction data. The method may also include disbursing at least one payment to the registered content creator based on the generated invoice.

According to another embodiment, a computer system for distributing a plurality of funds to a plurality of content creators is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include registering a content creator using a plurality of content creator identifying information when a user visits a content creator webpage. The method may also include receiving a plurality of user interaction data when the user visits the content creator webpage of a registered content creator. The method may further include generating an invoice based on the received plurality of user interaction data. The method may also include disbursing at least one payment to the registered content creator based on the generated invoice.

According to yet another embodiment, a computer program product for distributing a plurality of funds to a plurality of content creators is provided. The computer program product may include one or more computer-readable storage devices and program instructions stored on at least one of the one or more tangible storage devices, the program instructions executable by a processor. The computer program product may include program instructions to register a content creator using a plurality of content creator identifying information when a user visits a content creator webpage. The computer program product may also include program instructions to receive a plurality of user interaction data when the user visits the content creator webpage of a registered content creator. The computer program product may further include program instructions to generate an invoice based on the received plurality of user interaction data. The computer program product may also include program instructions to disburse at least one payment to the registered content creator based on the generated invoice.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a direct payment process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to payment systems. The following described exemplary embodiments provide a system, method, and program product to, among other things, implement a convenient system for web content consumers to disburse funds to content creators and/or providers. Therefore, the present embodiment has the capacity to improve the technical field of payment systems by allowing users to seamlessly designate and distribute funding to content creators and/or providers based on the most favored user content, either quantitatively or qualitatively, on a preconfigured basis.

As previously described, a payment system is a system used to process transactions, usually monetary transactions, between entities. Typically, a payment system operates as a network that creates a monetary exchange between individual accounts, such as bank accounts, to allow for the transfer of money. Payment systems may be physical or, with the rise of computing, electronic. Payment systems may include debit cards, credit cards, electronic fund transfers, direct credits, direct debits, internet banking, and e-commerce payment systems.

When a user consumes internet content, a great deal of advertisements may be presented to the user since a significant amount of web content is paid through advertisements placed alongside web content. In some instances, such as native advertising, advertisements may be placed within web content. Due to the extreme amount of advertisement content experienced on the internet, many consumers may be driven away from internet content that displays an exorbitant number of advertisements since such web content may be malicious or presented in a provocative nature intended to attract attention and visitors to web page.

In order to avoid undesirable advertising content, some content providers choose to generate revenue through consumer donations to pay for operating costs and generate profit. Such an arrangement may be favorable for both consumers and the content provider since the content provider receives funding to produce favorable web content while consumers are able to view new content. Typically, content providers wishing to generate funding use crowdfunding websites to which consumers are referred if the consumer wishes to donate to the content provider. Crowdfunding is the practice of obtaining funding from a large number of consumers. Some popular crowdfunding platforms allow content providers to run a funding campaign to generate funds. However, a new funding campaign may be required each time a content creator needs additional funding rather than simply receive payment when new content is released. Other crowdfunding platforms allow consumers to subscribe to a particular content creator's work. While such a platform provides a means for recurring support of the content creator, the consumer may not wish to invest so much funding at one time or so often based on the amount of content consumed. For example, a consumer may wish to consume all content ever produced by a content creator at one time and provide funding for that work, but the consumer may not wish to provide recurring payments. As such, it may be advantageous to, among other things, implement a passive direct payment system to allow consumers to disburse funds to content creators based on the content consumed by the user.

According to one embodiment, an opt-in consumer analytics platform, such as a browser plugin that records a user's internet browser traffic, may be utilized to take note of the content consumed by the user and the providers of the consumed content. For example, if a user frequented a blog twice a week, the platform may record the amount of text read and the author of the blog. Similarly, when a user watches videos on a video uploading and sharing website, the platform may record the video creator and the total number of posted videos watched. Additionally, the platform may record the payment information for the content creator so a direct payment may be made to the content creator's payment account. On a user-preconfigured schedule, the user may be prompted to disburse payment for web content. The user may be presented with a proposed invoice to content providers with recommended payment amounts based on the amount of content consumed. If desired, the user may manually adjust the payments to each content creator before submitting payments from the user's payment account to the content creator.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to record user web content consumption and provide a periodic report to allow the user to conveniently disburse funds to content creators.

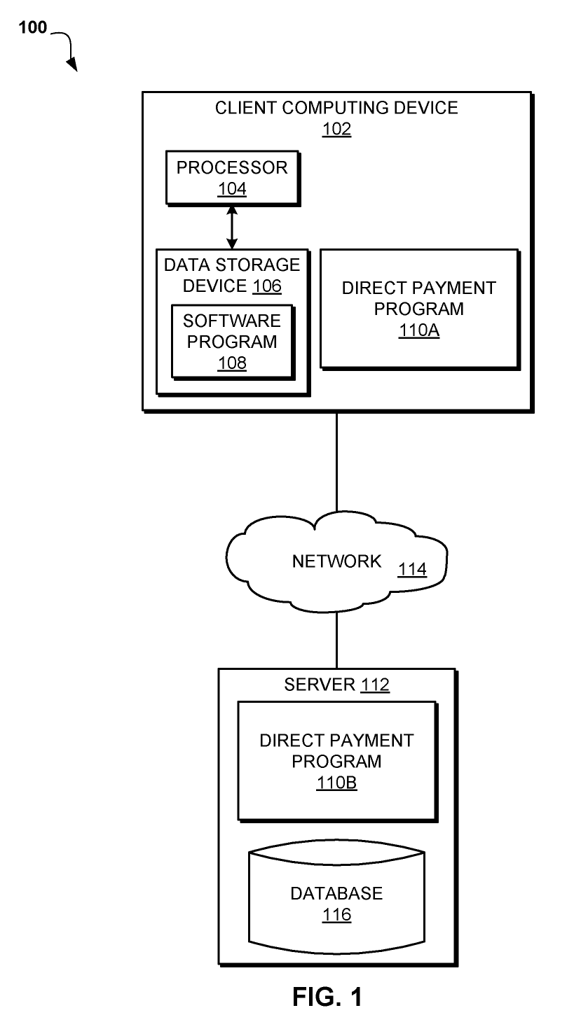

Referring to FIG. 1, an exemplary networked computer environment 100 is depicted, according to at least one embodiment. The networked computer environment 100 may include a client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

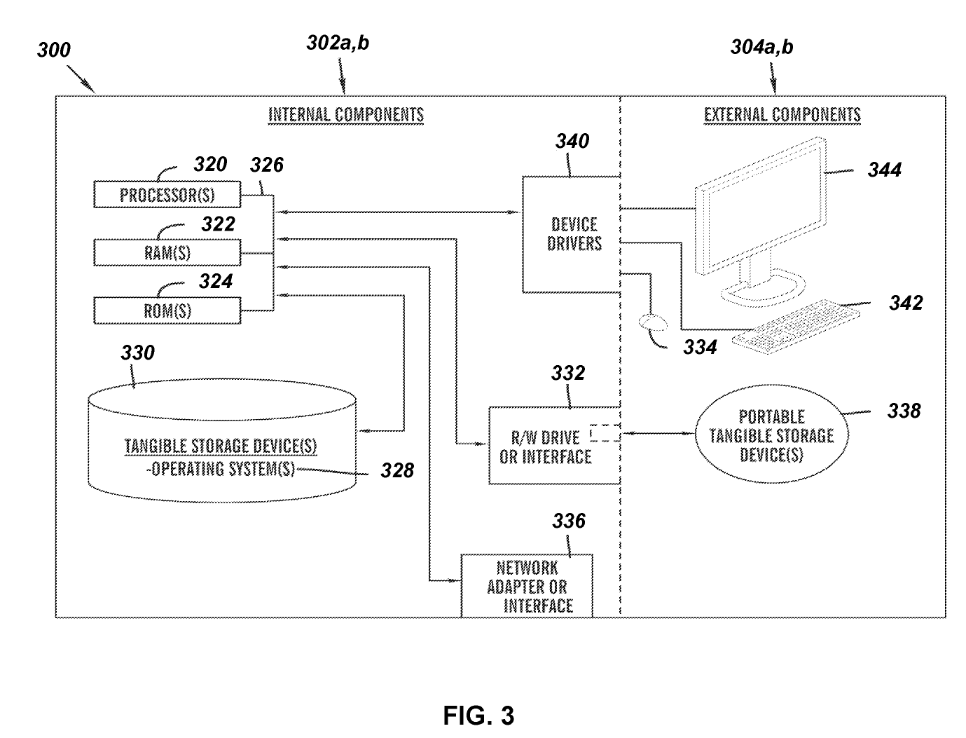

The client computing device 102 may include a processor 104 and a data storage device 106 that is enabled to host and run a software program 108 and a direct payment program 110A and communicate with the server 112 via the communication network 114, in accordance with one embodiment of the invention. The client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a direct payment program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

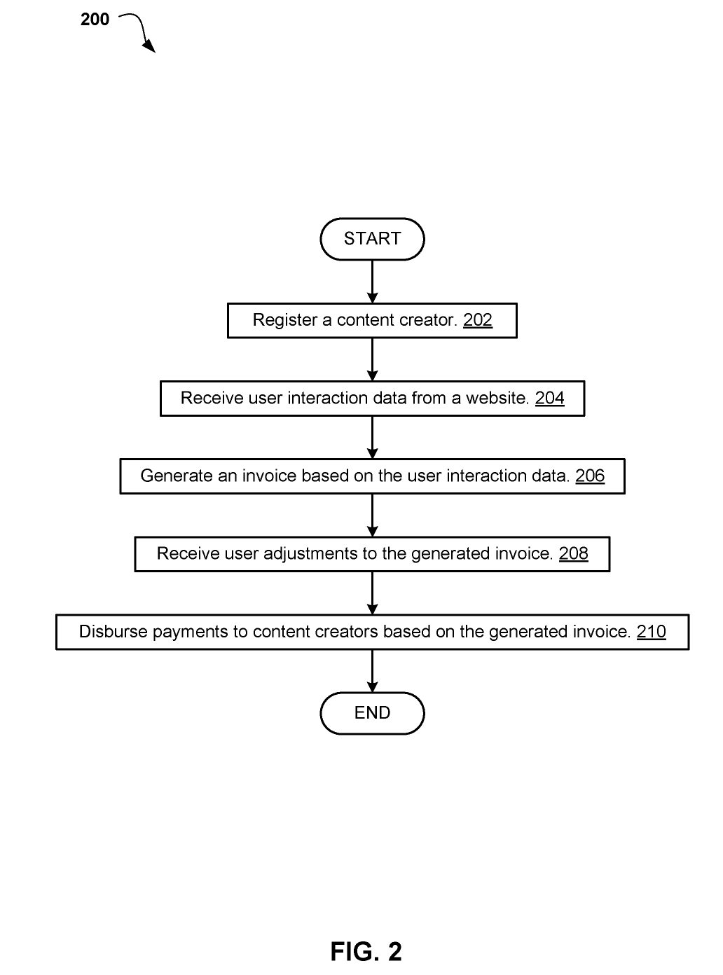

According to the present embodiment, the direct payment program 110A, 110B may be a program capable of gathering user consumption of web content and disbursing funds to content creators based on the user's content consumption over a preconfigured period of time. The direct payment method is explained in further detail below with respect to FIG. 2.

Referring now to FIG. 2, an operational flowchart illustrating a direct payment process 200 is depicted according to at least one embodiment. At 202, the direct payment program 110A, 110B registers a content creator. When a user visits a content creator website for the first time, the direct payment program 110A, 110B may register the content creator and log identifying information associated with the content creator in order to begin recording information related to the user interactions on the content creator webpage. For example, when a user first visits a content creator webpage, the direct payment program 110A, 110B may register identifying information of the content creator page, such as the Uniform Resource Locator of the content creator webpage, content creator name, and payment information for the content creator, to a data repository, such as database 116.

Next, at 204, the direct payment program 110A, 110B receives user interaction data from a website. Each time a user visits a website, the direct payment program 110A, 110B may record user interaction data with the webpage, such as the amount and type of content consumed. The amount of content consumed may include the total time watching a video or listening to an audio clip, words scrolled through in an article or online message post, or number of images viewed on a webpage. For example, if a user visits a content creator's video sharing webpage, the direct payment program 110A, 110B may record user interaction data, such as the total number of watched videos, the name of each watched video, and the amount of time the user spent watching each video. Furthermore, the direct payment program 110A, 110B may store the user interaction data within a data repository, such as database 116.

Then, at 206, the direct payment program 110A, 110B generates an invoice based on the user interaction data. At user preconfigured intervals, the direct payment program 110A, 110B may generate an invoice based on the stored user interaction data for each content creator. When generating the invoice, the direct payment program 110A, 110B may prompt the user to specify the amount of funds to be disbursed to content creators. The user may specify the amount to be disbursed through user interactions with a graphical user interface on a display screen of a user device, such as client computing device 102. The direct payment program 110A, 110B may tabulate the invoice based on a variety of payment schemes, such as amount, niche, tip jar, or host vs. author. The amount payment scheme allocates the funds based on the amount of content consumed. For example, content watched most by the user may receive the highest funding amount. The niche payment scheme may award funds based on the overall popularity of the content. For example, if the user watches content that is consumed by a smaller group of users, the direct payment program 110A, 110B may disburse more funds to the creator of the less popular content. The tip jar payment scheme may allow a user to manually approve the amount of money to a specific creator when viewing the content through user interactions with a graphical user interface. For example, if a user likes a video on a content creator webpage, the user may select an icon associated with the direct payment program 110A, 110B that will increase the amount of funds disbursed to the content creator during the next distribution period. The host vs. author payment scheme may allow a user to decide how to distribute funds between a content creator and the content publisher. For example, a user may wish to provide funds to a content author rather than the publisher that posted the author's article on a community webpage.

Next, at 208, the direct payment program 110A, 110B receives user adjustments to the generated invoice. Once the invoice is generated, the direct payment program 110A, 110B may present the invoice to the user on a graphical user interface to allow the user to review the invoice. The direct payment program 110A, 110B may allow the user to make manual adjustments to the proposed funding figures on the generated invoice calculated through the preconfigured payment scheme. For example, if the direct payment program 110A, 110B allocates $20 of funding to a specific content creator based on the user's content consumption habits and the preconfigured payment scheme, the user may manually increase or decrease the funding amount based on user preference.

Then, at 210, the direct payment program 110A, 110B disburses payments to content creators based on the generated invoice. Once the user is satisfied with the values on the invoice, the direct payment program 110A, 110B may disburse payment to the content creators based on the payment information stored within the data repository. For example, if the invoice allocates $20 to a specific content creator and the user wishes to charge the invoice amount to a debit card, the direct payment program 110A, 110B may transfer the $20 from the user's account to the content creator's account based on the payment information obtained by the direct payment program 110A, 110B from the content creator's webpage. Additionally, the direct payment program 110A, 110B may be preconfigured with the user's payment card information to allow for immediate disbursement of the funds or the direct payment program 110A, 110B may prompt the user to enter payment account information when the user submits each invoice.

It may be appreciated that FIG. 2 provides only an illustration of one implementation and does not imply any limitations with regard to how different embodiments may be implemented. Many modifications to the depicted environments may be made based on design and implementation requirements.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302a,b and external components 304a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the direct payment program 110A in the client computing device 102 and the direct payment program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the direct payment program 110A, 110B, can be stored on one or more of the respective portable computer-readable tangible storage devices 338, read via the respective R/W drive or interface 332, and loaded into the respective hard drive 330.

Each set of internal components 302a,b also includes network adapters or interfaces 336 such as a TCP/IP adapter cards, wireless Wi-Fi interface cards, or 3G or 4G wireless interface cards or other wired or wireless communication links. The software program 108 and the direct payment program 110A in the client computing device 102 and the direct payment program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the direct payment program 110A in the client computing device 102 and the direct payment program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

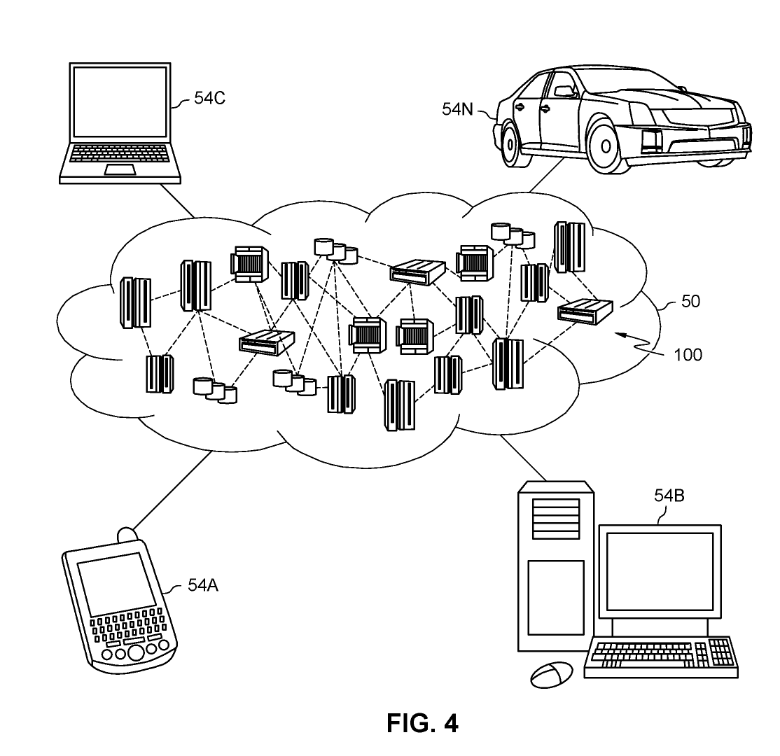

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

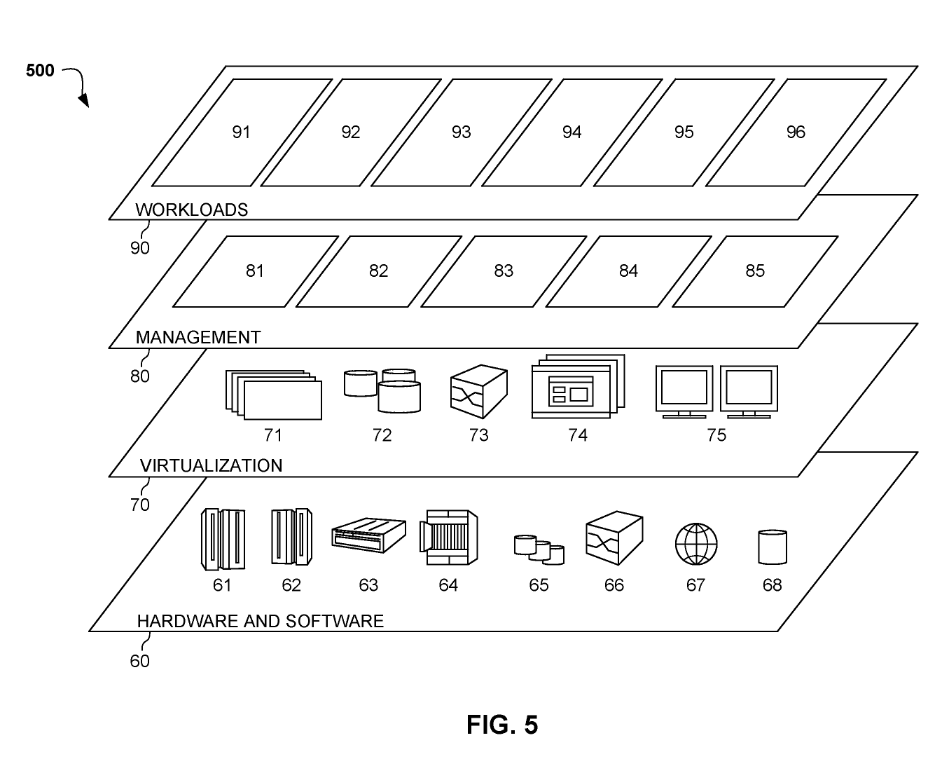

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and direct payment to content creators 96. Direct payment to content creators 96 may relate to gathering internet content consumption information for a user over a period, generating an invoice that allocates funds in a preconfigured payment scheme to each content creator, and disbursing funds to each content creator based on the generated invoice.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for distributing a plurality of funds to a plurality of content creators, the method comprising:
registering, by a processor, a content creator using a plurality of content creator identifying information when a user visits a content creator webpage;
receiving a plurality of user interaction data when the user visits the content creator webpage of the registered content creator;
generating an invoice based on the received plurality of user interaction data; and
disbursing at least one payment to the registered content creator based on the generated invoice.

2. The method of claim 1, wherein the invoice allocates a payment amount to each registered content creator within a plurality of registered content creators based on a payment scheme, and wherein the payment scheme is selected from the group consisting of a user-consumed content amount, an overall content creator popularity among a plurality of users, and a plurality of user selections to increase the payment amount.

3. The method of claim 1, further comprising:
receiving a plurality of manual user adjustments to the generated invoice.

4. The method of claim 1, wherein the plurality of content creator identifying information is selected from the group consisting of a Uniform Resource Locator of the content creator webpage, a content creator name, and a plurality of payment information associated with the content creator.

5. The method of claim 4, wherein disbursing the at least one payment includes transmitting a plurality of funds from a user payment account to a content creator payment account based on the plurality of payment information for the registered content creator.

6. The method of claim 3, wherein the plurality of manual user adjustments include changing a payment amount to the registered content creator and changing a payee to whom the at least one payment is to be disbursed.

7. The method of claim 1, wherein the plurality of user interaction data is selected from the group consisting of a total time viewing a video, a total time listening to an audio clip, a plurality of words scrolled through in an article or an online message post, and a total number of a plurality of images viewed on a webpage.

8. A computer system for distributing a plurality of funds to a plurality of content creators, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
registering a content creator using a plurality of content creator identifying information when a user visits a content creator webpage;
receiving a plurality of user interaction data when the user visits the content creator webpage of the registered content creator;
generating an invoice based on the received plurality of user interaction data; and
disbursing at least one payment to the registered content creator based on the generated invoice.

9. The computer system of claim 8, wherein the invoice allocates a payment amount to each registered content creator within a plurality of registered content creators based on a payment scheme, and wherein the payment scheme is selected from the group consisting of a user-consumed content amount, an overall content creator popularity among a plurality of users, and a plurality of user selections to increase the payment amount.

10. The computer system of claim 8, further comprising:
receiving a plurality of manual user adjustments to the generated invoice.

11. The computer system of claim 8, wherein the plurality of content creator identifying information is selected from the group consisting of a Uniform Resource Locator of the content creator webpage, a content creator name, and a plurality of payment information associated with the content creator.

12. The computer system of claim 11, wherein disbursing the at least one payment includes transmitting a plurality of funds from a user payment account to a content creator payment account based on the plurality of payment information for the registered content creator.

13. The computer system of claim 10, wherein the plurality of manual user adjustments include changing a payment amount to the registered content creator and changing a payee to whom the at least one payment is to be disbursed.

14. The computer system of claim 8, wherein the plurality of user interaction data is selected from the group consisting of a total time viewing a video, a total time listening to an audio clip, a plurality of words scrolled through in an article or an online message post, and a total number of a plurality of images viewed on a webpage.

15. A computer program product for distributing a plurality of funds to a plurality of content creators, the computer program product comprising:
one or more computer-readable tangible storage medium and program instructions stored on at least one of the one or more tangible storage medium, the program instructions executable by a processor, the program instructions comprising:
program instructions to register a content creator using a plurality of content creator identifying information when a user visits a content creator webpage;
program instructions to receive a plurality of user interaction data when the user visits the content creator webpage of the registered content creator;
program instructions to generate an invoice based on the received plurality of user interaction data; and
program instructions to disburse at least one payment to the registered content creator based on the generated invoice.

16. The computer program product of claim 15, wherein the invoice allocates a payment amount to each registered content creator within a plurality of registered content creators based on a payment scheme, and wherein the payment scheme is selected from the group consisting of a user-consumed content amount, an overall content creator popularity among a plurality of users, and a plurality of user selections to increase the payment amount.

17. The computer program product of claim 15, further comprising:
program instructions to receive a plurality of manual user adjustments to the generated invoice.

18. The computer program product of claim 15, wherein the plurality of content creator identifying information is selected from the group consisting of a Uniform Resource Locator of the content creator webpage, a content creator name, and a plurality of payment information associated with the content creator.

19. The computer program product of claim 18, wherein disbursing the at least one payment includes transmitting a plurality of funds from a user payment account to a content creator payment account based on the plurality of payment information for the registered content creator.

20. The computer program product of claim 17, wherein the plurality of manual user adjustments include changing a payment amount to the registered content creator and changing a payee to whom the at least one payment is to be disbursed.
